(19) United States
(12) Patent Application Publication
(10) Pub. No.: US 2023/0316299 A1
(43) Pub. Date: Oct. 5, 2023

(54) SYSTEMS AND METHODS FOR TRACKING EMISSIONS

(71) Applicant: nZero, Inc., Carson City, NV (US)

(72) Inventors: Joshua WEBER, Portland, OR (US); John RULA, Seattle, WA (US)

(21) Appl. No.: 18/192,212

(22) Filed: Mar. 29, 2023

Related U.S. Application Data
(63) Continuation of application No. PCT/US2023/016566, filed on Mar. 28, 2023.
(60) Provisional application No. 63/325,406, filed on Mar. 30, 2022.

(51) Int. Cl. G06Q 30/018; G06Q 50/06

(52) U.S. Cl. CPC G06Q 30/018; G06Q 50/06

(57) ABSTRACT

The present disclosure provides methods and systems for tracking emissions, comprising: (a) receiving or obtaining power or energy data associated with a generation or use of power or energy; (b) modeling the generation or use of the power or energy, based at least in part on: (1) the power or energy data, and (2) a financial ownership of the power or energy, a financial obligation or responsibility associated with the generation or use of the power or energy, or financial data associated with the generation or use of the power or energy; and (c) computing or deriving greenhouse gas (GHG) intensity or emission values for (i) one or more sources that generate the power or energy, (ii) one or more entities that consume or utilize the power or energy, (iii) a market or exchange for the power or energy, or (iv) an electrically-defined area, based on the modeling.

### CROSS-REFERENCE TO RELATED APPLICATIONS

This application is a continuation of International Application No. PCT/US2023/016566, filed Mar. 28, 2023, which claims the benefit of U.S. Provisional Application No. 63/325,406, filed Mar. 30, 2022, each of which are incorporated herein by reference in their entirety.

### BACKGROUND

Power or energy can be generated and transmitted or distributed over a network or a grid. The generation of the power or energy can produce various emissions, including greenhouse gas (GHG) emissions. The emissions can be tracked or monitored over time to provide insights on how energy use and commercial activities can impact GHG emission levels.

### SUMMARY

Accurate, detailed and real-time grid emissions calculations are critical to successfully measure and reduce greenhouse gas (GHG) emissions. Recognized herein are various limitations with emission accounting systems and methods currently available. Existing approaches to GHG accounting may involve modeling the physical flow of electricity, without considering the financial carbon responsibility required for accurate GHG accounting. Such modeling based on the physical flow of electrons can yield an overly simplistic approach to GHG accounting that is unable to provide faithful, true, and fair reporting of an entity's or organization's actual GHG emissions.

The present disclosure provides enhanced systems and methods for GHG accounting that allow for hour-by-hour tracking of localized grid emissions based at least in part on the complex legal and financial ownership stakes in energy purchasing and consumption. The presently disclosed systems and methods may be implemented to model entire system level flows of the generation, consumption, and transfer of electricity within an interconnected grid, on a time scale that is sufficiently granular to provide individuals and entities with an accurate measurement of the GHG emissions generated in connection with their commercial activities and/or energy usage.

The present application relates generally to systems, methods, and media for tracking emissions. In one aspect, the present disclosure provides methods comprising: (a) receiving or obtaining power or energy data associated with a generation, a transmission, a distribution, or a consumption of power or energy; (b) modeling the generation, sale, purchase, transmission, distribution, receipt, consumption, or utilization of the power or energy, based at least in part on: (1) the power or energy data, and (2) a financial ownership of the power or energy, a financial obligation or responsibility associated with the generation, sale, transmission, distribution, receipt, or consumption of the power or energy, or financial data associated with the generation, sale, transmission, distribution, receipt, or consumption of the power or energy; and (c) computing or deriving greenhouse gas (GHG) intensity or emission values for (i) one or more sources that generate the power or energy, (ii) one or more entities that consume or utilize the power or energy, (iii) a market or exchange for the power or energy, or (iv) an electrically-defined area or region, based on the modeling in (b). In some embodiments, the power or energy is transmitted or distributed over a network, a grid, a macrogrid, or a microgrid. In some embodiments, the network or grid comprises an electrical grid.

In some embodiments, (b) further comprises modeling a transmission, a flux, or a flow path of one or more greenhouse gases (GHGs) based on the power or energy data. In some embodiments, the transmission, flux, or flow path of the GHGs represents or corresponds to an amount of GHG emissions attributable to the one or more entities consuming or utilizing the power or energy. In some embodiments, the flow of GHGs represents or corresponds to an amount of GHG emissions attributable to the one or more entities based on a financial obligation or responsibility of the one or more entities for the power or energy. In some embodiments, the amount of GHG emissions attributable to the one or more entities consuming or utilizing the power or energy corresponds to an amount of GHG emissions generated to produce the power or energy consumed or utilized by the one or more entities. In some embodiments, the amount of GHG emissions attributable to the one or more entities corresponds to an amount of GHG emissions generated to produce power or energy for which the one or more entities have a financial obligation or responsibility.

In some embodiments, the generation, sale, transmission, or receipt of the power or energy is modeled based at least in part on a physical transmission of power or energy between the one or more sources and the one or more entities. In some embodiments, the generation, sale, transmission or receipt of the power or energy is determined based at least in part on the financial ownership of the power or energy or an obligation or financial responsibility for the power or energy. In some embodiments, the financial responsibility is determined based at least in part on the transmission or distribution of the power or energy.

In some embodiments, the GHG intensity or emission values comprise a localized or individualized GHG intensity or emission value corresponding to an amount of GHGs emitted per unit of electrical energy generated. In some embodiments, the GHG intensity or emission values are computed based on power or energy data from a plurality of sources comprising the one or more sources. In some embodiments, the GHG intensity or emission values are computed based on a weighted averaging, transformation, or integration of at least a subset of the power or energy data for the plurality of sources. In some embodiments, the GHG intensity or emission values are computed based at least in part on the transmission, flux, or flow path of the one or more greenhouse gases. In some embodiments, the GHG intensity or emission values are computed based on at least one local grid factor. In some embodiments, the at least one local grid factor comprises a type of electricity generated, transmitted, distributed, or consumed.

In some embodiments, the localized GHG intensity or emission values are computed periodically at a time interval ranging from 1 second to 1 year. In some embodiments, the localized GHG intensity or emission values are computed hourly. In some embodiments, the localized GHG intensity or emission values are computed in real time.

In some embodiments, the method may further comprise computing power or energy consumption for (i) the one or more sources, (ii) the one or more entities, (iii) the market or exchange for the power or energy, or (iv) the electrically-defined area or region, based on at least one local grid factor. In some embodiments, the at least one local grid factor comprises a type of electricity generated, transmitted, distributed, or consumed. In some embodiments, the GHG intensity or emission values are computed based at least in part on the power or energy consumption.

In some embodiments, the power or energy data is associated with one or more financial instruments. In some embodiments, the one or more financial instruments comprise a power purchase agreement (PPA), a virtual PPA, a market purchase agreement, a guarantee of origin, a renewable energy credit, or a utility tariff. In some embodiments, the power or energy data comprises ownership information for the one or more sources. In some embodiments, the power or energy data comprises operational data for the one or more sources. In some embodiments, the operational data comprises power or energy generation rates, a type of fuel or source material processed to generate the power or energy, a total amount of electricity generated per unit time, and/or heat rates for the one or more sources. In some embodiments, the power or energy data comprises data on electricity transmission or distribution.

In some embodiments, the one or more sources comprise a plant or a facility for generating the power or energy. In some embodiments, the electrically-defined area or region comprises a balancing area or a subdivision or a subsection thereof. In some embodiments, the electrically-defined area or region comprises a portion or a section of a grid system or a grid network for receiving, transmitting, and/or distributing the power or energy.

Another aspect of the present disclosure provides a system comprising one or more computer processors and computer memory coupled thereto. The computer memory comprises machine executable code that, upon execution by the one or more computer processors, implements any of the methods above or elsewhere herein. In one aspect, the present disclosure provides systems, comprising at least one processor, an operating system configured to perform executable instructions, a memory, and instructions executable by the at least one processor to cause the at least one processor to perform operations comprising: (a) receiving or obtaining power or energy data associated with a generation, a transmission, a distribution, or a consumption of power or energy; (b) modeling the generation, sale, purchase, transmission, distribution, receipt, consumption, or utilization of the power or energy, based at least in part on: (1) the power or energy data, and (2) a financial ownership of the power or energy, a financial obligation or responsibility associated with the generation, sale, transmission, distribution, receipt, or consumption of the power or energy, or financial data associated with the generation, sale, transmission, distribution, receipt, or consumption of the power or energy; and (c) computing or deriving greenhouse gas (GHG) intensity or emission values for (i) one or more sources that generate the power or energy, (ii) one or more entities that consume or utilize the power or energy, (iii) a market or exchange for the power or energy, or (iv) an electrically-defined area or region, based on the modeling. In some embodiments, the modeling comprises modeling a transmission, a flux, or a flow path of one or more greenhouse gases (GHGs) based on the power or energy data. In further embodiments, the transmission, flux, or flow path of the GHGs represents or corresponds to an amount of GHG emissions attributable to the one or more entities consuming or utilizing the power or energy. In other embodiments, the flow of GHGs represents or corresponds to an amount of GHG emissions attributable to the one or more entities based on a financial obligation or responsibility of the one or more entities for the power or energy. In further embodiments, the amount of GHG emissions attributable to the one or more entities consuming or utilizing the power or energy corresponds to an amount of GHG emissions generated to produce the power or energy consumed or utilized by the one or more entities. In other embodiments, the amount of GHG emissions attributable to the one or more entities corresponds to an amount of GHG emissions generated to produce power or energy for which the one or more entities have a financial obligation or responsibility. In some embodiments, the modeling is further based at least in part on a physical transmission of power or energy between the one or more sources and the one or more entities. In some embodiments, the modeling is based at least in part on the financial ownership of the power or energy or an obligation for the power or energy. In some embodiments, in the modeling, the financial responsibility is determined based at least in part on the transmission or distribution of the power or energy. In some embodiments, the GHG intensity or emission values comprise a localized or individualized GHG intensity or emission value corresponding to an amount of GHGs emitted per unit of electrical energy generated. In some embodiments, the GHG intensity or emission values are computed based on power or energy data from a plurality of sources comprising the one or more sources. In further embodiments, the GHG intensity or emission values are computed based on a weighted averaging, transformation, or integration of at least a subset of the power or energy data for the plurality of sources. In some embodiments, the GHG intensity or emission values are computed based at least in part on the transmission, flux, or flow path of the one or more greenhouse gases. In some embodiments, the GHG intensity or emission values are computed based on at least one local grid factor. In further embodiments, the at least one local grid factor comprises a type of electricity generated, transmitted, distributed, or consumed. In some embodiments, the operations further comprise computing power or energy consumption for (i) the one or more sources, (ii) the one or more entities, (iii) the market or exchange for the power or energy, or (iv) the electrically-defined area or region, based on at least one local grid factor. In further embodiments, the at least one local grid factor comprises a type of electricity generated, transmitted, distributed, or consumed. In still further embodiments, the GHG intensity or emission values are computed based at least in part on the power or energy consumption. In some embodiments, the power or energy data is associated with one or more financial instruments. In further embodiments, the one or more financial instruments comprise a power purchase agreement (PPA), a virtual PPA, a market purchase agreement, a guarantee of origin, a renewable energy credit, or a utility tariff. In some embodiments, the power or energy data comprises ownership information for the one or more sources. In some embodiments, the power or energy data comprises operational data for the one or more sources, wherein the operational data comprises power or energy generation rates, a type of fuel or source material processed to generate the power or energy, a total amount of electricity generated per unit time, and/or heat rates for the one or more sources. In some embodiments, the power or energy data comprises data on electricity transmission or distribution. In some embodiments, the one or more sources comprise a plant or a facility for generating the power or energy. In some embodiments, the power or energy is transmitted or distributed over a network, a grid, a macrogrid, or a microgrid. In further embodiments, the network or grid comprises an electrical grid. In some embodiments, the localized GHG intensity or emission values are computed periodically at a time interval ranging from about 1 second to about 1 year. In further embodiments, the localized GHG intensity or emission values are computed at least hourly. In still further embodiments, the localized GHG intensity or emission values are computed substantially in real time or in real time. In some embodiments, the electrically-defined area or region comprises a balancing area or a subdivision or a subsection thereof. In some embodiments, the electrically-defined area or region comprises a portion or a section of a grid system or a grid network for receiving, transmitting, and/or distributing the power or energy.

Another aspect of the present disclosure provides a non-transitory computer readable medium comprising machine executable code that, upon execution by one or more computer processors, implements any of the methods above or elsewhere herein. In one aspect, the present disclosure provides non-transitory computer-readable storage media encoded with instructions executable by one or more processors to create an application comprising: (a) a software module receiving or obtaining (e.g., configured to receive or obtain) power or energy data associated with a generation, a transmission, a distribution, or a consumption of power or energy; (b) a software module modeling (e.g., configured to model) the generation, sale, purchase, transmission, distribution, receipt, consumption, or utilization of the power or energy, based at least in part on: (1) the power or energy data, and (2) a financial ownership of the power or energy, a financial obligation or responsibility associated with the generation, sale, transmission, distribution, receipt, or consumption of the power or energy, or financial data associated with the generation, sale, transmission, distribution, receipt, or consumption of the power or energy; and (c) a software module computing or deriving (e.g., configured to compute or derive) greenhouse gas (GHG) intensity or emission values for (i) one or more sources that generate the power or energy, (ii) one or more entities that consume or utilize the power or energy, (iii) a market or exchange for the power or energy, or (iv) an electrically-defined area or region, based on the modeling. In some embodiments, the software module modeling the generation, sale, purchase, transmission, distribution, receipt, consumption, or utilization of the power or energy further models a transmission, a flux, or a flow path of one or more greenhouse gases (GHGs) based on the power or energy data. In further embodiments, the transmission, flux, or flow path of the GHGs represents or corresponds to an amount of GHG emissions attributable to the one or more entities consuming or utilizing the power or energy. In other embodiments, the flow of GHGs represents or corresponds to an amount of GHG emissions attributable to the one or more entities based on a financial obligation or responsibility of the one or more entities for the power or energy. In further embodiments, the amount of GHG emissions attributable to the one or more entities consuming or utilizing the power or energy corresponds to an amount of GHG emissions generated to produce the power or energy consumed or utilized by the one or more entities. In other embodiments, the amount of GHG emissions attributable to the one or more entities corresponds to an amount of GHG emissions generated to produce power or energy for which the one or more entities have a financial obligation or responsibility. In some embodiments, the software module modeling the generation, sale, purchase, transmission, distribution, receipt, consumption, or utilization of the power or energy models the generation, sale, transmission, or receipt of the power or energy based at least in part on a physical transmission of power or energy between the one or more sources and the one or more entities. In some embodiments, the software module modeling the generation, sale, purchase, transmission, distribution, receipt, consumption, or utilization of the power or energy models the generation, sale, transmission or receipt of the power or energy based at least in part on the financial ownership of the power or energy or an obligation for the power or energy. In some embodiments, the software module modeling the generation, sale, purchase, transmission, distribution, receipt, consumption, or utilization of the power or energy determines the financial responsibility based at least in part on the transmission or distribution of the power or energy. In some embodiments, the GHG intensity or emission values comprise a localized or individualized GHG intensity or emission value corresponding to an amount of GHGs emitted per unit of electrical energy generated. In some embodiments, the software module computing or deriving the GHG intensity or emission values computes or derives the GHG intensity or emission values based on power or energy data from a plurality of sources comprising the one or more sources. In further embodiments, the software module computing or deriving the GHG intensity or emission values computes or derives the GHG intensity or emission values based on a weighted averaging, transformation, or integration of at least a subset of the power or energy data for the plurality of sources. In some embodiments, the software module computing or deriving the GHG intensity or emission values computes or derives the GHG intensity or emission values based at least in part on the transmission, flux, or flow path of the one or more greenhouse gases. In some embodiments, the software module computing or deriving the GHG intensity or emission values computes or derives the GHG intensity or emission values based on at least one local grid factor. In further embodiments, the at least one local grid factor comprises a type of electricity generated, transmitted, distributed, or consumed. In some embodiments, the application further comprises a software module computing (e.g., configured to compute) power or energy consumption for (i) the one or more sources, (ii) the one or more entities, (iii) the market or exchange for the power or energy, or (iv) the electrically-defined area or region, based on at least one local grid factor. In further embodiments, the at least one local grid factor comprises a type of electricity generated, transmitted, distributed, or consumed. In still further embodiments, the GHG intensity or emission values are computed based at least in part on the power or energy consumption. In some embodiments, the power or energy data is associated with one or more financial instruments. In further embodiments, the one or more financial instruments comprise a power purchase agreement (PPA), a virtual PPA, a market purchase agreement, a guarantee of origin, a renewable energy credit, or a utility tariff. In some embodiments, the power or energy data comprises ownership information for the one or more sources. In some embodiments, the power or energy data comprises operational data for the one or more sources, wherein the operational data comprises power or energy generation rates, a type of fuel or source material processed to generate the power or energy, a total amount of electricity generated per unit time, and/or heat rates for the one or more sources. In some embodiments, the power or energy data comprises data on electricity transmission or distribution. In some embodiments, the one or more sources comprise a plant or a facility for generating the power or energy. In some embodiments, the power or energy is transmitted or distributed over a network, a grid, a macrogrid, or a microgrid. In further embodiments, the network or grid comprises an electrical grid. In some embodiments, the software module computing or deriving greenhouse gas (GHG) intensity or emission values computes or derives the localized GHG intensity or emission values periodically at a time interval ranging from about 1 second to about 1 year. In further embodiments, the software module computing or deriving greenhouse gas (GHG) intensity or emission values computes or derives the localized GHG intensity or emission values are computed at least hourly. In still further embodiments, the software module computing or deriving greenhouse gas (GHG) intensity or emission values computes or derives the localized GHG intensity or emission values in substantially in real time or in real time. In some embodiments, the electrically-defined area or region comprises a balancing area or a subdivision or a subsection thereof. In some embodiments, the electrically-defined area or region comprises a portion or a section of a grid system or a grid network for receiving, transmitting, and/or distributing the power or energy.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates an exemplary system for computing, deriving, and/or tracking GHG emissions, in accordance with some embodiments;

FIG. 2A schematically illustrates an exemplary scenario in which a consumer purchases electricity directly from a plant through a power purchase agreement (PPA);

FIG. 2B schematically illustrates a modeling approach for the exemplary scenario in FIG. 2A, in accordance with some embodiments;

FIG. 3A schematically illustrates an example of a utility within a balancing authority;

FIG. 3B schematically illustrates a modeling approach for the exemplary scenario in FIG. 3A, in accordance with some embodiments;

FIG. 4A schematically illustrates a conventional method of modeling emissions using the path of electricity;

FIG. 4B schematically illustrates an enhanced modeling approach whereby the topology for the generation, sale, purchase, transmission, distribution, receipt, consumption, or utilization of the power or energy is updated to account for transactions involving and ownership interests in the power or energy, in accordance with some embodiments; and

FIG. 5 schematically illustrates a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “real time” or “real-time,” as used interchangeably herein, generally refers to an event (e.g., an operation, a process, a method, a technique, a computation, a calculation, an analysis, a visualization, an optimization, etc.) that is performed using recently obtained (e.g., collected or received) data. In some cases, a real time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more, including increments therein. In some cases, a real time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less, including increments therein. As used herein, the term “real time” or “real-time” may also include operations (e.g., calculations or computations of GHG intensity or emission values) that can be performed within a certain time period after receiving power or energy data. The time period may range from about 1 minute to about 1 hour. In some cases, the time period may be less than 1 minute. In some cases, the time period may be less than 1 hour. In any of the embodiments described herein, the time period may be less than 1 day.

### Overview

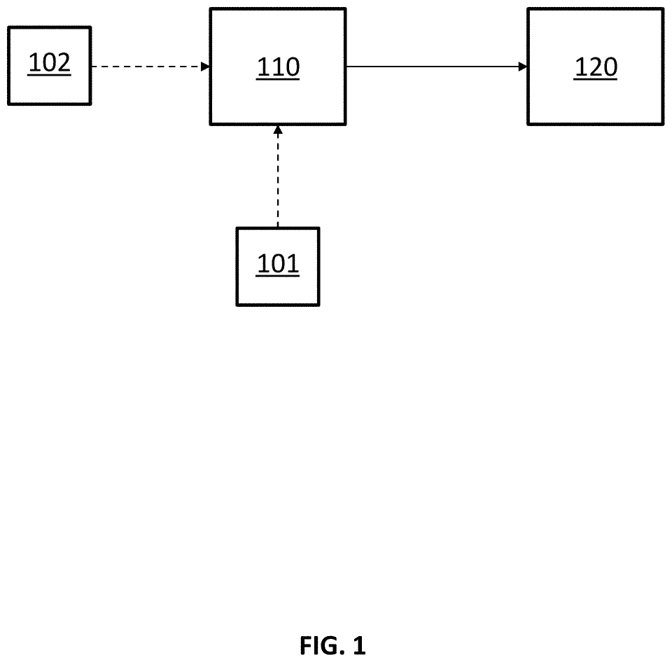

The present disclosure provides systems and methods for computing, deriving, and/or tracking emissions. FIG. 1 illustrates an exemplary system 110 for computing, deriving, and/or tracking GHG emissions. The GHG emissions may comprise, for example, methane (CH₄), or any carbon oxide (CO_{X}) or nitrogen oxide (NO_{X}) gas. The carbon oxide may comprise, for example, carbon monoxide (CO) or carbon dioxide (CO₂). The nitrogen oxide may comprise, for example, NO₃, NO₂, NO, N₂O, N₂O₂, N₂O₃, N₂O₄, or N₂O₅.

The system 110 may comprise one or more processing units and/or one or more memory modules. The one or more processing units may be configured to model the generation, sale, purchase, transmission, distribution, receipt, consumption, or utilization of the power or energy, based at least in part on power or energy data 101. The power or energy data 101 may be obtained from the one or more memory modules. In some embodiments, the power or energy data 101 may be obtained directly from one or more remote sources (e.g., a remote server). In some embodiments, the power or energy data 101 may be received by a direct input from a human operator.

In some embodiments, the one or more processing units may be configured to model the generation, sale, purchase, transmission, distribution, receipt, consumption, or utilization of the power or energy, based at least in part on additional data or information 102. The additional data or information 102 may comprise, for example, a financial ownership of the power or energy, a financial obligation or responsibility associated with the generation, sale, transmission, distribution, receipt, or consumption of the power or energy, or financial data associated with the generation, sale, transmission, distribution, receipt, or consumption of the power or energy. The additional data or information 102 may be obtained from the one or more memory modules. In some embodiments, the additional data or information 102 may be obtained directly from one or more remote sources (e.g., a remote server). In some embodiments, the additional data or information 102 may be received by a direct input from a human operator.

In some embodiments, the one or more processing units may be configured to compute or derive greenhouse gas (GHG) intensity or emission values for (i) one or more sources that generate the power or energy, (ii) one or more entities that consume or utilize the power or energy, (iii) a market or exchange for the power or energy, or (iv) an electrically-defined area or region, based on the modeling performed by the processing units.

The greenhouse gas (GHG) intensity or emission values may be computed periodically or in real time as the power or energy data 101 is received. In any of the embodiments described herein, the greenhouse gas (GHG) intensity or emission values may be computed periodically at a time interval ranging from 1 millisecond (ms) to 2 year. In any of the embodiments described herein, the greenhouse gas (GHG) intensity or emission values may be computed periodically at a time interval ranging from about 1 ms to about 100 ms, about 1 ms to about 500 ms, about 1 ms to about 1 second, about 1 ms to about 30 seconds, about 1 ms to about 1 minute, about 1 ms to about 10 minutes, about 1 ms to about 30 minutes, about 1 ms to about 1 hour, about 1 ms to about 2 hours, about 1 ms to about 6 hours, about 1 ms to about 12 hours, about 1 ms to about 24 hours, about 1 ms to about 2 days, about 1 ms to about 7 days, about 1 ms to about 2 weeks, about 1 ms to about 1 month, about 1 ms to about 2 months, about 1 ms to about 6 months, about 1 ms to about 1 year, about 1 ms to about 2 years, about 100 ms to about 500 ms, about 100 ms to about 1 second, about 100 ms to about 30 seconds, about 100 ms to about 1 minute, about 100 ms to about 10 minutes, about 100 ms to about 30 minutes, about 100 ms to about 1 hour, about 100 ms to about 2 hours, about 100 ms to about 6 hours, about 100 ms to about 12 hours, about 100 ms to about 24 hours, about 100 ms to about 2 days, about 100 ms to about 7 days, about 100 ms to about 2 weeks, about 100 ms to about 1 month, about 100 ms to about 2 months, about 100 ms to about 6 months, about 100 ms to about 1 year, about 100 ms to about 2 years, about 500 ms to about 1 second, about 500 ms to about 30 seconds, about 500 ms to about 1 minute, about 500 ms to about 10 minutes, about 500 ms to about 30 minutes, about 500 ms to about 1 hour, about 500 ms to about 2 hours, about 500 ms to about 6 hours, about 500 ms to about 12 hours, about 500 ms to about 24 hours, about 500 ms to about 2 days, about 500 ms to about 7 days, about 500 ms to about 2 weeks, about 500 ms to about 1 month, about 500 ms to about 2 months, about 500 ms to about 6 months, about 500 ms to about 1 year, about 500 ms to about 2 years, about 1 seconds to about 30 seconds, about 1 second to about 1 minute, about 1 second to about 10 minutes, about 1 second to about 30 minutes, about 1 second to about 1 hour, about 1 second to about 2 hours, about 1 second to about 6 hours, about 1 second to about 12 hours, about 1 second to about 24 hours, about 1 second to about 2 days, about 1 second to about 7 days, about 1 second to about 2 weeks, about 1 second to about 1 month, about 1 second to about 2 months, about 1 second to about 6 months, about 1 second to about 1 year, about 1 second to about 2 years, about 30 seconds to about 1 minute, about 30 seconds to about 10 minutes, about 30 seconds to about 30 minutes, about 30 seconds to about 1 hour, about 30 seconds to about 2 hours, about 30 seconds to about 6 hours, about 30 seconds to about 12 hours, about 30 seconds to about 24 hours, about 30 seconds to about 2 days, about 30 seconds to about 7 days, about 30 seconds to about 2 weeks, about 30 seconds to about 1 month, about 30 seconds to about 2 months, about 30 seconds to about 6 months, about 30 seconds to about 1 year, about 30 seconds to about 2 years, about 1 minute to about 10 minutes, about 1 minute to about 30 minutes, about 1 minute to about 1 hour, about 1 minute to about 2 hours, about 1 minute to about 6 hours, about 1 minute to about 12 hours, about 1 minute to about 24 hours, about 1 minute to about 2 days, about 1 minute to about 7 days, about 1 minute to about 2 weeks, about 1 minute to about 1 month, about 1 minute to about 2 months, about 1 minute to about 6 months, about 1 minute to about 1 year, about 1 minute to about 2 years, about 10 minutes to about 30 minutes, about 10 minutes to about 1 hour, about 10 minutes to about 2 hours, about 10 minutes to about 6 hours, about 10 minutes to about 12 hours, about 10 minutes to about 24 hours, about 10 minutes to about 2 days, about 10 minutes to about 7 days, about 10 minutes to about 2 weeks, about 10 minutes to about 1 month, about 10 minutes to about 2 months, about 10 minutes to about 6 months, about 10 minutes to about 1 year, about 10 minutes to about 2 years, about 30 minutes to about 1 hour, about 30 minutes to about 2 hours, about 30 minutes to about 6 hours, about 30 minutes to about 12 hours, about 30 minutes to about 24 hours, about 30 minutes to about 2 days, about 30 minutes to about 7 days, about 30 minutes to about 2 weeks, about 30 minutes to about 1 month, about 30 minutes to about 2 months, about 30 minutes to about 6 months, about 30 minutes to about 1 year, about 30 minutes to about 2 years, about 1 hour to about 2 hours, about 1 hour to about 6 hours, about 1 hour to about 12 hours, about 1 hour to about 24 hours, about 1 hour to about 2 days, about 1 hour to about 7 days, about 1 hour to about 2 weeks, about 1 hour to about 1 month, about 1 hour to about 2 months, about 1 hour to about 6 months, about 1 hour to about 1 year, about 1 hour to about 2 years, about 2 hours to about 6 hours, about 2 hours to about 12 hours, about 2 hours to about 24 hours, about 2 hours to about 2 days, about 2 hours to about 7 days, about 2 hours to about 2 weeks, about 2 hours to about 1 month, about 2 hours to about 2 months, about 2 hours to about 6 months, about 2 hours to about 1 year, about 2 hours to about 2 years, about 6 hours to about 12 hours, about 6 hours to about 24 hours, about 6 hours to about 2 days, about 6 hours to about 7 days, about 6 hours to about 2 weeks, about 6 hours to about 1 month, about 6 hours to about 2 months, about 6 hours to about 6 months, about 6 hours to about 1 year, about 6 hours to about 2 years, about 12 hours to about 24 hours, about 12 hours to about 2 days, about 12 hours to about 7 days, about 12 hours to about 2 weeks, about 12 hours to about 1 month, about 12 hours to about 2 months, about 12 hours to about 6 months, about 12 hours to about 1 year, about 12 hours to about 2 years, about 24 hours to about 2 days, about 24 hours to about 7 days, about 24 hours to about 2 weeks, about 24 hours to about 1 month, about 24 hours to about 2 months, about 24 hours to about 6 months, about 24 hours to about 1 year, about 24 hours to about 2 years, about 2 days to about 7 days, about 2 days to about 2 weeks, about 2 days to about 1 month, about 2 days to about 2 months, about 2 days to about 6 months, about 2 days to about 1 year, about 2 days to about 2 years, about 7 days to about 2 weeks, about 7 days to about 1 month, about 7 days to about 2 months, about 7 days to about 6 months, about 7 days to about 1 year, about 7 days to about 2 years, about 2 weeks to about 1 month, about 2 weeks to about 2 months, about 2 weeks to about 6 months, about 2 weeks to about 1 year, about 2 weeks to about 2 years, about 1 month to about 2 months, about 1 month to about 6 months, about 1 month to about 1 year, about 1 month to about 2 years, about 2 months to about 6 months, about 2 months to about 1 year, about 2 months to about 2 years, about 6 months to about 1 year, about 6 months to about 2 years, or about 1 year to about 2 years. In any of the embodiments described herein, the greenhouse gas (GHG) intensity or emission values may be computed periodically at a time interval of about 1 ms, about 100 ms, about 500 ms, about 1 second, about 30 seconds, about 1 minute, about 10 minutes, about 30 minutes, about 1 hour, about 2 hours, about 6 hours, about 12 hours, about 24 hours, about 2 days, about 7 days, about 2 weeks, about 1 month, about 2 months, about 6 months, about 1 year, or about 2 years, including increments therein. In any of the embodiments described herein, the GHG intensity or emission values may be computed periodically at an hourly time interval.

In some embodiments, the system 110 may be operatively coupled to a display unit 120. The display unit 120 may be integrated with the system 110, or may be a component of the system 110. Alternatively, the display unit 120 may be located remotely from the system 110. The display unit 120 may be associated with an individual or an entity who is interested in viewing, tracking, or monitoring GHG emissions associated with an event or an activity. The system 110 may be configured to transmit data or information on the computed or derived greenhouse gas (GHG) intensity or emission values to the display unit 120 to enable the tracking or monitoring of GHG emissions over time.

### Methods

In an aspect, the present disclosure provides a method for computing, deriving, and/or tracking emissions. The computation, derivation, or tracking of emissions may be used for accounting purposes (e.g., greenhouse gas accounting) or for informational purposes (e.g., to provide insights into how certain activities or transactions impact greenhouse gas emissions).

In some embodiments, the method may comprise (a) receiving or obtaining power or energy data associated with a generation, a transmission, a distribution, or a consumption of power or energy. In some embodiments, the method may comprise (b) modeling the generation, sale, transmission, distribution, receipt, and/or consumption of the power or energy based at least in part on the power or energy data. In some embodiments, the method may comprise (c) computing or deriving greenhouse gas (GHG) intensity or emission values for (i) the one or more sources, (ii) the one or more entities, (iii) a market or exchange for the power or energy, or (iv) an electrically-defined area or region, based at least in part on the modeling in (b).

### Power/Energy Data

In some embodiments, the method may comprise receiving or obtaining power or energy data. In some embodiments, the power or energy may comprise or correspond to power or energy that can be transmitted or distributed through a network. In some cases, the network may comprise a grid (e.g., an electrical grid), a microgrid, or a macrogrid. The microgrid or macrogrid may be connected to a grid and/or can operate independently of the grid.

The power or energy data may be received or obtained from, for example, power generation sources, Environmental Protection Agency (EPA) databases, or public commissions that release operational data (e.g., heat rates) for sources that generate the power or energy. In some cases, the power or energy data may be received or obtained from a computer memory or database that is accessible via a network or a physical interconnection with a memory module storing the power or energy data. In some cases, the power or energy data may be received or obtained from one or more physical sources of information (e.g., memory modules associated with servers or computers, files, documents, etc.). In some cases, the power or energy data may be received or obtained from one or more virtual sources of information (e.g., cloud storage, cloud servers, etc.). In some cases, the power or energy data may be received or obtained from a human that interprets and manually inputs the power or energy data from one or more physical or virtual sources of information.

In some cases, the power or energy data may be received or obtained periodically or at a predetermined time interval, with the frequency of publication being dependent on the information source. Data publication frequency may vary from approximately 1-3-day delay in most cases, to 3-month publication delays in the case of plant generation data within the US. In some embodiments, data at initial publication may be corrected later. In some embodiments, redundant capture efforts may be required to schedule to ensure retrieving the corrected data. In some cases, the power or energy data may be received or obtained after querying a data source comprising the power or energy data. In some cases, the power or energy data may be received or obtained in real-time as the power or energy data is published, generated, recorded, or logged.

### Data Content

In some cases, the power or energy data may be associated with a generation, a sale, a purchase, a transmission, a distribution, a receipt, a consumption, and/or a utilization of power or energy. In some embodiments, the generation, sale, purchase, transmission, distribution, receipt, and/or consumption of the power or energy may involve, for example, one or more sources that generate the power or energy, one or more electrically-defined areas or regions, one or more markets or exchanges for the power or energy, and/or one or more entities that buy, sell, transmit, distribute, receive, consume, or otherwise utilize the power or energy.

In some embodiments, the power or energy data may comprise data on electricity transmission or distribution. Such data may include, for example, an amount of electricity transmitted or distributed, a rate at which the electricity is transmitted or distributed, or the current, voltage, or power associated with the electricity being transmitted or distributed. In some cases, the data may comprise information on where the electricity is being transmitted or distributed. In some cases, the data may comprise information on the physical or virtual pathways used to transmit or distribute the electricity.

In some embodiments, the power or energy data may comprise data on where the electricity is generated, or where the electricity originates from. In some cases, the power or energy data may comprise ownership information for one or more sources that produce the power or electricity.

In some embodiments, the power or energy data may comprise operational data for the one or more sources. In some cases, the operational data may comprise, for example, power or energy generation rates, a type of fuel or source material processed to generate the power or energy, a total amount of electricity generated per unit time, and/or heat rates for the one or more sources.

In some embodiments, the power or energy data may be associated with a financial instrument. The financial instrument may comprise, for example, a power purchase agreement (PPA), a virtual PPA, a market purchase agreement, a guarantee of origin, a renewable energy credit, or a utility tariff.

### Modeling

In some embodiments, the method may comprise modeling the generation, sale, purchase, transmission, distribution, receipt, consumption, and/or utilization of the power or energy. In some embodiments, the generation, sale, purchase, transmission, distribution, receipt, and/or consumption of the power or energy may involve, for example, one or more sources that generate the power or energy, one or more electrically-defined areas or regions, one or more markets or exchanges for the power or energy, and/or one or more entities that buy, sell, transmit, distribute, receive, consume, or otherwise utilize the power or energy. In some embodiments, the method may comprise modeling the generation, sale, purchase, transmission, distribution, receipt, consumption, and/or utilization of the power or energy, comprising training and/or applying a machine learning model. In some embodiments, the machine learning model may comprise a supervised machine learning model. In some embodiments, the supervised machine learning model may comprise logistic regression model, support vector machine (SVM), Naïve Bayes, Decision Trees, Linear Regression, k Nearest Neighbors (kNN), Random Forest, or Boosting algorithms. In some embodiments, the machine learning model may comprise an unsupervised machine learning. In some embodiments, the unsupervised machine learning may comprise K-Means algorithm or Hierarchical Clustering algorithm. In some embodiments, the machine learning model may comprise a Deep Learning Model. In some embodiments, the Deep Learning Model may comprise large amount of un-structured data. In some embodiments, the Deep Learning Model may comprise performing graphic recognition or natural language processing. In some embodiments, the machine learning model may comprise a time-series machine learning model. In some embodiments, the time-series machine learning may comprise variables or attributes with a successive length of time. Time series machine learning models are used to predict time-bound events, for example—consumption of the power or energy for a future week, or greenhouse gas (GHG) emission values for next year, and so on. In some embodiments, the length of time may be seconds, minutes, hours, days, weeks, months, or years.

In some embodiments, the method may comprise modeling the generation, sale, purchase, transmission, distribution, receipt, consumption, and/or utilization of the power or energy based at least in part on the power or energy data. The power or energy data may be received or obtained from any of the data sources described elsewhere herein, and using any of the methods or procedures described elsewhere herein (including any similar or equivalent methods or procedures).

In some embodiments, the generation, sale, purchase, transmission, distribution, receipt, consumption, and/or utilization of the power or energy may be modeled based at least in part on a physical transmission of electrons between one or more sources and one or more entities that consume or utilize the power or energy. In some embodiments, the transmission and distribution of the power or energy may be modeled based at least in part on a physical transmission of electrons between the one or more sources and (i) a market or exchange for the power or energy, or (ii) an electrically-defined area or region.

### Financial Ownership/Obligation/Responsibility

In some embodiments, the method may comprise modeling the generation, sale, purchase, transmission, distribution, receipt, consumption, and/or utilization of the power or energy based at least in part on one or more additional factors. The one or more additional factors may include, for example, information on a financial ownership of the power or energy, a financial obligation or responsibility associated with the generation, sale, purchase, transmission, distribution, receipt, consumption, or utilization of the power or energy, or financial data associated with the generation, sale, purchase, transmission, distribution, receipt, consumption, or utilization of the power or energy. The generation, sale, purchase, transmission, distribution, receipt, consumption, and/or utilization of the power or energy may involve, for example, one or more sources that generate the power or energy, one or more electrically-defined areas or regions, one or more markets or exchanges for the power or energy, and/or one or more entities that buy, sell, transmit, distribute, receive, consume, or otherwise utilize the power or energy. In some embodiments, the generation, sale, transmission, or receipt of the power or energy may be determined based at least in part on the financial ownership of the power or energy or an obligation for the power or energy.

The generation, sale, purchase, transmission, distribution, receipt, consumption, and/or utilization of the power or energy may be modeled using (i) information on a financial ownership of the power or energy, (ii) a financial obligation or responsibility associated with the generation, sale, purchase, transmission, distribution, receipt, consumption, or utilization of the power or energy, or (iii) financial data associated with the generation, sale, purchase, transmission, distribution, receipt, consumption, or utilization of the power or energy. In some cases, (i) the information on the financial ownership of the power or energy, (ii) the financial obligation or responsibility associated with the generation, sale, purchase, transmission, distribution, receipt, consumption, or utilization of the power or energy, and/or (iii) the financial data associated with the generation, sale, purchase, transmission, distribution, receipt, consumption, or utilization of the power or energy may be derived or obtained from a financial instrument or a data source. In some cases, the financial instrument or data source may document a transaction or operation involving the generation, sale, purchase, transmission, distribution, receipt, consumption, or utilization of the power or energy. The financial instrument may comprise, for example, a power purchase agreement (PPA), a virtual PPA, a market purchase agreement, a guarantee of origin, a renewable energy credit, or a utility tariff.

In any of the embodiments described herein, the modeling of the generation, sale, purchase, transmission, distribution, receipt, consumption, and/or utilization of the power or energy may comprise identifying, determining, and/or assigning an amount of energy usage and/or GHG emissions to an individual, an entity, or an electrically defined region or area. The electrically defined region or area may correspond to, for instance, at least a portion of a geographical area, or at least a portion of a grid or a network for the power or energy.

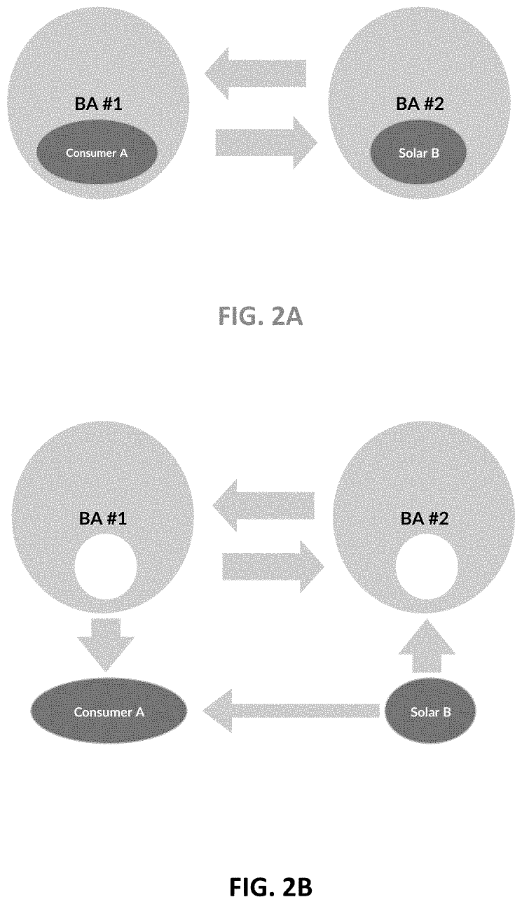

FIG. 2A illustrates a scenario in which a first consumer A purchases electricity directly from a solar plant B through a power purchase agreement (PPA). Consumer A may be associated with a first balancing authority and solar plant B may be associated with a second balancing authority. Current methods cannot isolate the purchased carbon-free electricity from grid-mix rates associated with the respective balancing authorities.

FIG. 2B illustrates a modeling approach that can be implemented using the presently disclosed systems and methods. The modeling may comprise separating out both consumer A and solar plant B from their respective electrically-defined regions (such as their respective balancing authorities), and connecting purchased power over a virtual transmission line extending from the consumer A directly to the solar plant B. The power flux through the virtual transmission line may be removed from the mix of energy associated with the electrically-defined region for consumer A or the electrically-defined region for solar plant B, to more accurately model or represent the composition of the power or energy flux for the electrically-defined regions.

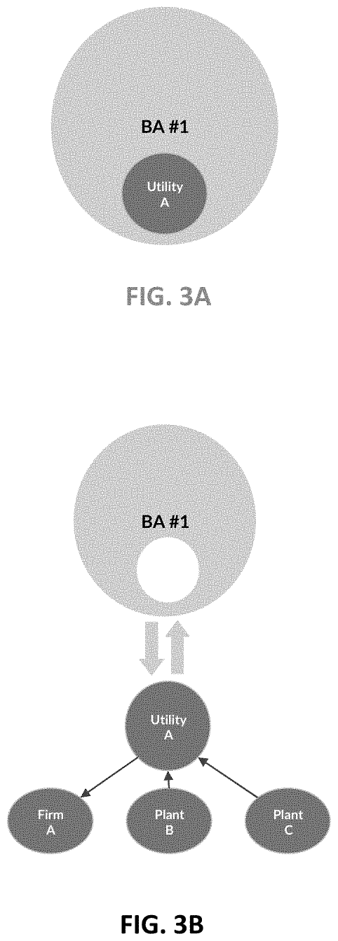

FIG. 3A illustrates a utility A within a balancing authority, which has its own generation and market purchases. In conventional methods, the GHG intensity rates for utility A are modeled to be the same as the parent balancing authority of the utility A. FIG. 3B illustrates a more accurate modeling approach that can be implemented using the presently disclosed systems and methods. The modeling methods of the present disclosure may be used to isolate a utility with its proprietary generation, dispatch, and purchase data. Such data can be carved out of the parent balancing authority and used to calculate the utility's GHG intensity directly, and to better represent the parent balancing authority's power or energy composition.

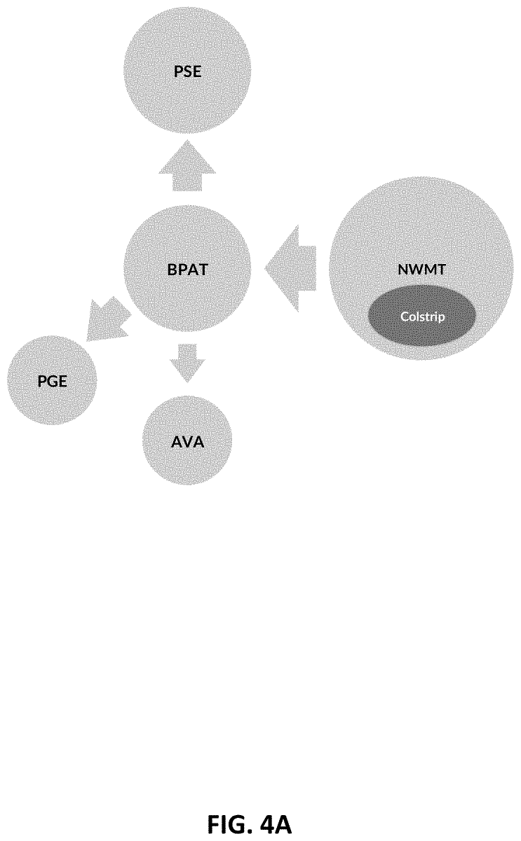

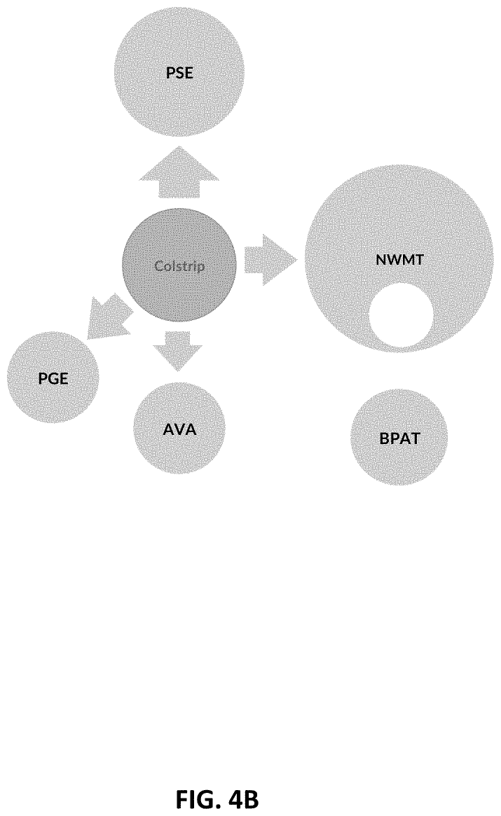

FIG. 4A illustrates a conventional method of modeling emissions using the path of electricity. A real-life scenario in which “Colstrip” represents the Colstrip Generating Station, a coal-fired power plant in Northwestern Energy's (“NWMT”) Balancing Area. Electric energy flows from Colstrip over the Bonneville Power Administration's transmission system (“BPAT”) to load sinks in the utility service territories of Puget Sound Energy (“PSE”), Portland General Electric (“PGE”), and Avista Corp. (“AVA”), which all purchase output from Colstrip. GHG emissions can be mixed within an intermediary node of a network or grid system, and can dilute or otherwise misrepresent downstream flows of GHGs. FIG. 4B illustrates an enhanced modeling approach whereby the topology for the generation, sale, purchase, transmission, distribution, receipt, consumption, or utilization of the power or energy is updated to account for transactions involving the power or energy and/or ownership interests in the power or energy (as opposed to just the physical flows of electrons). In the example shown in FIG. 4B, the intermediate balancing authority (BPAT) may be bypassed entirely when modeling the GHG emissions attributable to other consuming entities or electrically-defined regions. The applicant's methodology assigns its emissions to each utility that has a financial interest in the plant, based on the proportion of that financial interest, as opposed to assigning all emissions to NWMT, as would occur under FIG. 4A.

### Modeling GHG Flux

In some embodiments, the method may further comprise modeling a transmission, a flux, or a flow path of one or more greenhouse gases (GHGs). In some cases, the transmission, flux, or flow path of the one or more greenhouse gases (GHGs) may be associated with the generation, transmission, distribution, and/or consumption of the power or energy. In some cases, the transmission, flux, or flow path of the one or more greenhouse gases (GHGs) may be modeled based on the power or energy data. As used herein, the term greenhouse gas or GHG may refer to any gaseous emission that can affect or influence the environment. As described elsewhere herein, the greenhouse gas may comprise methane (CH₄), or any carbon oxide (CO_{X}) or nitrogen oxide (NO_{X}) gas. The carbon oxide may comprise, for example, carbon monoxide (CO) or carbon dioxide (CO₂). The nitrogen oxide may comprise, for example, NO₃, NO₂, NO, N₂O, N₂O₂, N₂O₃, N₂O₄, or N₂O₅. In any of the embodiments described herein, the greenhouse gas may comprise any other type of gas comprising carbon, hydrogen, nitrogen, and/or oxygen.

In some embodiments, the flow of GHGs may represent an amount of GHG emissions attributable to the one or more entities consuming or utilizing the power or energy. In some embodiments, the amount of GHG emissions attributable to the one or more entities consuming or utilizing the power or energy may correspond to an amount of GHG emissions generated to produce the power or energy consumed or utilized by the one or more entities. In some embodiments, the flow of GHGs may represent an amount of GHG emissions attributable to one or more entities based on the entities' financial obligation or responsibility for the power or energy. In some embodiments, the amount of GHG emissions attributable to the one or more entities may correspond to an amount of GHG emissions generated to produce power or energy for which the one or more entities have a financial obligation or responsibility.

### GHG Emission Values

In some embodiments, the method may comprise computing or deriving greenhouse gas (GHG) intensity or emission values. The greenhouse gas (GHG) intensity or emission values may be associated with (i) one or more sources for generating the power or energy, (ii) one or more entities that consume or utilize the power or energy, (iii) a market or exchange for the power or energy, or (iv) an electrically-defined area or region. In some embodiments, the greenhouse gas (GHG) intensity or emission values may be computed or derived based on the modeling of the generation, sale, purchase, transmission, distribution, receipt, consumption, and/or utilization of the power or energy.

In some embodiments, the method may comprise computing or deriving greenhouse gas (GHG) intensity or emission values for (i) the one or more sources, (ii) the one or more entities, (iii) the market or exchange for the power or energy, or (iv) the electrically-defined area or region. In some embodiments, the greenhouse gas (GHG) intensity or emission values may be computed or derived based on a modeling of the direct transmission and distribution of the power or energy from the one or more sources to the one or more entities. In some embodiments, the method may comprise computing or deriving greenhouse gas (GHG) intensity or emission values based on a modeling of the generation, purchase, sale, transmission, distribution, receipt, consumption, and/or utilization of the power or energy across a network or a grid.

In some cases, the greenhouse gas (GHG) intensity or emission values may be computed or derived based on (1) the power or energy data received or obtained from one or more data sources, and/or (2) a financial ownership of the power or energy, a financial obligation or responsibility associated with the generation, sale, purchase, transmission, distribution, receipt, consumption, and/or utilization of the power or energy, or financial data associated with the generation, sale, purchase, transmission, distribution, receipt, consumption, and/or utilization of the power or energy. In some cases, the greenhouse gas (GHG) intensity or emission values may be computed or derived based on the transmission, flux, or flow path of the one or more greenhouse gases. In some cases, the greenhouse gas (GHG) intensity or emission values may be computed or derived based on the transmission, flux, or flow path of one or more electrons within or through a network or a grid. In some cases, the greenhouse gas (GHG) intensity or emission values may be computed or derived based on at least one local grid factor. As used herein, the term “local grid factor” may refer to one or more properties, characteristics, or attributes of the energy produced for a particular area or a particular portion of a grid. In some non-limiting embodiments, the term “local grid factor” may also refer to one or more properties, operational characteristics, or attributes of the sources or facilities used to produce energy for a particular area or a particular portion of a grid. In some embodiments, the at least one local grid factor may comprise, for example, a type of electricity generated, transmitted, distributed, and/or consumed. In some embodiments, the local grid factor may reflect an average thermal efficiency (e.g., energy content of the fuel versus energy produced) for one or more sources (e.g., electrical generation facilities) providing electricity to a local electrical grid.

In some embodiments, the GHG intensity or emission values may comprise a localized or individualized GHG intensity or emission value corresponding to an amount of GHGs emitted per unit of electrical energy generated. In some embodiments, the GHG intensity or emission values may be computed based on power or energy data from a plurality of sources that can each individually generate power or energy. In some embodiments, the GHG intensity or emission values may be computed based on a weighted averaging, transformation, or integration of at least a subset of the power or energy data for the plurality of sources. In some embodiments, the GHG intensity or emission values may be computed based at least in part on the consumption, transmission, distribution, and/or generation of the power or energy.

In some embodiments, the localized GHG intensity or emission values may be computed periodically at a time interval. The time interval may range from about 1 millisecond (ms) to about 2 years. In some embodiments, the localized GHG intensity or emission values may be computed hourly. In some embodiments, the localized GHG intensity or emission values may be computed in real time.

As described elsewhere herein, the real time computations may involve computing the GHG intensity or emission values after receiving power or energy data. In any of the embodiments described herein, calculations or computations of the GHG intensity or emission values can be performed within a time period after receiving power or energy data. In any of the embodiments described herein, the time period may range from about 1 millisecond (ms) to about 5 days. In any of the embodiments described herein, the time period may range from about 1 ms to about 10 ms, about 1 ms to about 100 ms, about 1 ms to about 500 ms, about 1 ms to about 1 second, about 1 ms to about 2 seconds, about 1 ms to about 10 seconds, about 1 ms to about 30 seconds, about 1 ms to about 1 minute, about 1 ms to about 2 minutes, about 1 ms to about 5 minutes, about 1 ms to about 10 minutes, about 1 ms to about 30 minutes, about 1 ms to about 1 hour, about 1 ms to about 2 hours, about 1 ms to about 6 hours, about 1 ms to about 12 hours, about 1 ms to about 1 day, about 1 ms to about 2 days, about 1 ms to about 3 days, about 1 ms to about 5 days, about 10 ms to about 100 ms, about 10 ms to about 500 ms, about 10 ms to about 1 second, about 10 ms to about 2 seconds, about 10 ms to about 10 seconds, about 10 ms to about 30 seconds, about 10 ms to about 1 minute, about 10 ms to about 2 minutes, about 10 ms to about 5 minutes, about 10 ms to about 10 minutes, about 10 ms to about 30 minutes, about 10 ms to about 1 hour, about 10 ms to about 2 hours, about 10 ms to about 6 hours, about 10 ms to about 12 hours, about 10 ms to about 1 day, about 10 ms to about 2 days, about 10 ms to about 3 days, about 10 ms to about 5 days, about 100 ms to about 500 ms, about 100 ms to about 1 second, about 100 ms to about 2 seconds, about 100 ms to about 10 seconds, about 100 ms to about 30 seconds, about 100 ms to about 1 minute, about 100 ms to about 2 minutes, about 100 ms to about 5 minutes, about 100 ms to about 10 minutes, about 100 ms to about 30 minutes, about 100 ms to about 1 hour, about 100 ms to about 2 hours, about 100 ms to about 6 hours, about 100 ms to about 12 hours, about 100 ms to about 1 day, about 100 ms to about 2 days, about 100 ms to about 3 days, about 100 ms to about 5 days, about 500 ms to about 1 second, about 500 ms to about 2 seconds, about 500 ms to about 10 seconds, about 500 ms to about 30 seconds, about 500 ms to about 1 minute, about 500 ms to about 2 minutes, about 500 ms to about 5 minutes, about 500 ms to about 10 minutes, about 500 ms to about 30 minutes, about 500 ms to about 1 hour, about 500 ms to about 2 hours, about 500 ms to about 6 hours, about 500 ms to about 12 hours, about 500 ms to about 1 day, about 500 ms to about 2 days, about 500 ms to about 3 days, about 500 ms to about 5 days, about 1 second to about 2 seconds, about 1 second to about 10 seconds, about 1 second to about 30 seconds, about 1 second to about 1 minute, about 1 second to about 2 minutes, about 1 second to about 5 minutes, about 1 second to about 10 minutes, about 1 second to about 30 minutes, about 1 second to about 1 hour, about 1 second to about 2 hours, about 1 second to about 6 hours, about 1 second to about 12 hours, about 1 second to about 1 day, about 1 second to about 2 days, about 1 second to about 3 days, about 1 second to about 5 days, about 2 seconds to about 10 seconds, about 2 seconds to about 30 seconds, about 2 seconds to about 1 minute, about 2 seconds to about 2 minutes, about 2 seconds to about 5 minutes, about 2 seconds to about 10 minutes, about 2 seconds to about 30 minutes, about 2 seconds to about 1 hour, about 2 seconds to about 2 hours, about 2 seconds to about 6 hours, about 2 seconds to about 12 hours, about 2 seconds to about 1 day, about 2 seconds to about 2 days, about 2 seconds to about 3 days, about 2 seconds to about 5 days, about 10 seconds to about 30 seconds, about 10 seconds to about 1 minute, about 10 seconds to about 2 minutes, about 10 seconds to about 5 minutes, about 10 seconds to about 10 minutes, about 10 seconds to about 30 minutes, about 10 seconds to about 1 hour, about 10 seconds to about 2 hours, about 10 seconds to about 6 hours, about 10 seconds to about 12 hours, about 10 seconds to about 1 day, about 10 seconds to about 2 days, about 10 seconds to about 3 days, about 10 seconds to about 5 days, about 30 seconds to about 1 minute, about 30 seconds to about 2 minutes, about 30 seconds to about 5 minutes, about 30 seconds to about 10 minutes, about 30 seconds to about 30 minutes, about 30 seconds to about 1 hour, about 30 seconds to about 2 hours, about 30 seconds to about 6 hours, about 30 seconds to about 12 hours, about 30 seconds to about 1 day, about 30 seconds to about 2 days, about 30 seconds to about 3 days, about 30 seconds to about 5 days, about 1 minute to about 2 minutes, about 1 minute to about 5 minutes, about 1 minute to about 10 minutes, about 1 minute to about 30 minutes, about 1 minute to about 1 hour, about 1 minute to about 2 hours, about 1 minute to about 6 hours, about 1 minute to about 12 hours, about 1 minute to about 1 day, about 1 minute to about 2 days, about 1 minute to about 3 days, about 1 minute to about 5 days, about 2 minutes to about 5 minutes, about 2 minutes to about 10 minutes, about 2 minutes to about 30 minutes, about 2 minutes to about 1 hour, about 2 minutes to about 2 hours, about 2 minutes to about 6 hours, about 2 minutes to about 12 hours, about 2 minutes to about 1 day, about 2 minutes to about 2 days, about 2 minutes to about 3 days, about 2 minutes to about 5 days, about 5 minutes to about 10 minutes, about 5 minutes to about 30 minutes, about 5 minutes to about 1 hour, about 5 minutes to about 2 hours, about 5 minutes to about 6 hours, about 5 minutes to about 12 hours, about 5 minutes to about 1 day, about 5 minutes to about 2 days, about 5 minutes to about 3 days, about 5 minutes to about 5 days, about 10 minutes to about 30 minutes, about 10 minutes to about 1 hour, about 10 minutes to about 2 hours, about 10 minutes to about 6 hours, about 10 minutes to about 12 hours, about 10 minutes to about 1 day, about 10 minutes to about 2 days, about 10 minutes to about 3 days, about 10 minutes to about 5 days, about 30 minutes to about 1 hour, about 30 minutes to about 2 hours, about 30 minutes to about 6 hours, about 30 minutes to about 12 hours, about 30 minutes to about 1 day, about 30 minutes to about 2 days, about 30 minutes to about 3 days, about 30 minutes to about 5 days, about 1 hour to about 2 hours, about 1 hour to about 6 hours, about 1 hour to about 12 hours, about 1 hour to about 1 day, about 1 hour to about 2 days, about 1 hour to about 3 days, about 1 hour to about 5 days, about 2 hours to about 6 hours, about 2 hours to about 12 hours, about 2 hours to about 1 day, about 2 hours to about 2 days, about 2 hours to about 3 days, about 2 hours to about 5 days, about 6 hours to about 12 hours, about 6 hours to about 1 day, about 6 hours to about 2 days, about 6 hours to about 3 days, about 6 hours to about 5 days, about 12 hours to about 1 day, about 12 hours to about 2 days, about 12 hours to about 3 days, about 12 hours to about 5 days, about 1 day to about 2 days, about 1 day to about 3 days, about 1 day to about 5 days, about 2 days to about 3 days, about 2 days to about 5 days, or about 3 days to about 5 days. In any of the embodiments described herein, the time period may be about 1 ms, about 10 ms, about 100 ms, about 500 ms, about 1 second, about 2 seconds, about 10 seconds, about 30 seconds, about 1 minute, about 2 minutes, about 5 minutes, about 1 minutes, about 30 minutes, about 1 hour, about 2 hours, about 6 hours, about 12 hours, about 1 day, about 2 days, about 3 days, or about 5 days. In any of the embodiments described herein, the time period may be within about 1 ms, about 10 ms, about 100 ms, about 500 ms, about 1 second, about 2 seconds, about 10 seconds, about 30 seconds, about 1 minute, about 2 minutes, about 5 minutes, about 10 minutes, about 30 minutes, about 1 hour, about 2 hours, about 6 hours, about 12 hours, about 1 day, about 2 days, about 3 days, or about 5 days.

### Power/Energy Consumption

In some embodiments, the method may comprise computing power or energy consumption for one or more sources that generate the power or energy. The one or more sources may comprise, for example, a plant or a facility for generating the power or energy. In some embodiments, the method may comprise computing power or energy consumption for one or more entities that utilize or consume the power or energy. In some embodiments, the method may comprise computing power or energy consumption for a market or exchange for the power or energy. In some embodiments, the method may comprise computing power or energy consumption for an electrically-defined area or region. In some cases, the electrically-defined area or region may comprise a balancing area or a subdivision or a subsection thereof. In some cases, the electrically-defined area or region may comprise a portion or a section of a grid system or a grid network for receiving, transmitting, and/or distributing the power or energy.

In any of the embodiments described herein, the power or energy consumption may be determined based on at least one local grid factor. In some cases, the at least one local grid factor may comprise a type of electricity generated, transmitted, distributed, and/or consumed.

### Computer Systems

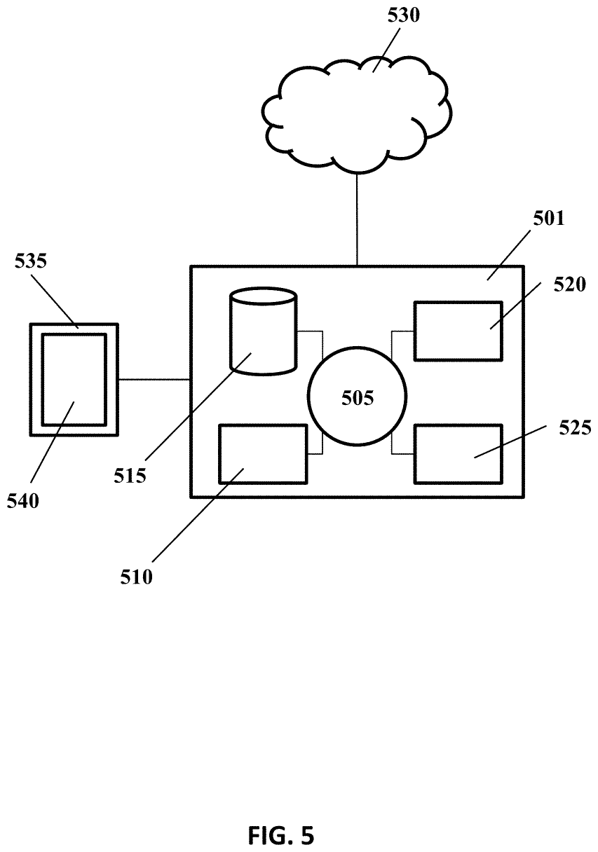

In an aspect, the present disclosure provides computer systems that are programmed or otherwise configured to implement methods of the disclosure, e.g., any of the subject methods for tracking or computing GHG emission values. FIG. 5 shows a computer system 501 that is programmed or otherwise configured to implement a method for tracking or computing GHG emission values. The computer system 501 may be configured to, for example, receive or obtain power or energy data associated with a generation, a transmission, a distribution, or a consumption of power or energy; model the generation, sale, purchase, transmission, distribution, receipt, consumption, or utilization of the power or energy, based at least in part on (1) the power or energy data, and (2) a financial ownership of the power or energy, a financial obligation or responsibility associated with the generation, sale, transmission, distribution, receipt, or consumption of the power or energy, or financial data associated with the generation, sale, transmission, distribution, receipt, or consumption of the power or energy; and compute or derive GHG intensity or emission values for (i) one or more sources that generate the power or energy, (ii) one or more entities that consume or utilize the power or energy, (iii) a market or exchange for the power or energy, or (iv) an electrically-defined area or region, based on the modeling of the generation, sale, purchase, transmission, distribution, receipt, consumption, or utilization of the power or energy. The computer system 501 can be an electronic device of a user or a computer system that is remotely located with respect to the electronic device. The electronic device can be a mobile electronic device.

The computer system 501 may include a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are located external to the computer system 501 (e.g., on a remote server that is in communication with the computer system 501 through an intranet or the Internet).

The computer system 501 can communicate with one or more remote computer systems through the network 530. For instance, the computer system 501 can communicate with a remote computer system of an end user or an entity monitoring or tracking the generation, sale, purchase, transmission, distribution, receipt, consumption, or utilization of the power or energy, or an end user or entity monitoring or tracking GHG emissions associated with the generation, sale, purchase, transmission, distribution, receipt, consumption, or utilization of the power or energy. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for providing, for example, a portal for a user to view the GHG intensity or emission values associated with one or more activities, events or transactions that involve the generation, sale, purchase, transmission, distribution, receipt, consumption, or utilization of the power or energy. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 505. For example, the algorithm may be configured to model the generation, sale, purchase, transmission, distribution, receipt, consumption, or utilization of power or energy, based at least in part on (1) power or energy data and (2) a financial ownership of the power or energy, a financial obligation or responsibility associated with the generation, sale, transmission, distribution, receipt, or consumption of the power or energy, or financial data associated with the generation, sale, transmission, distribution, receipt, or consumption of the power or energy. In some embodiments, the algorithm may be further configured to compute or derive GHG intensity or emission values for (i) one or more sources that generate the power or energy, (ii) one or more entities that consume or utilize the power or energy, (iii) a market or exchange for the power or energy, or (iv) an electrically-defined area or region, based on the modeling of the generation, sale, transmission, distribution, receipt, or consumption of the power or energy.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method, comprising:
(a) receiving or obtaining power or energy data associated with a generation, a transmission, a distribution, or a consumption of power or energy;
(b) modeling the generation, sale, purchase, transmission, distribution, receipt, consumption, or utilization of the power or energy, based at least in part on:
(1) the power or energy data, and
(2) a financial ownership of the power or energy, a financial obligation or responsibility associated with the generation, sale, transmission, distribution, receipt, or consumption of the power or energy, or financial data associated with the generation, sale, transmission, distribution, receipt, or consumption of the power or energy; and
(c) computing or deriving greenhouse gas (GHG) intensity or emission values for (i) one or more sources that generate the power or energy, (ii) one or more entities that consume or utilize the power or energy, (iii) a market or exchange for the power or energy, or (iv) an electrically-defined area or region, based on the modeling in (b).

2. The method of claim 1, wherein (b) further comprises modeling a transmission, a flux, or a flow path of one or more greenhouse gases (GHGs) based on the power or energy data.

3. The method of claim 2, wherein the transmission, flux, or flow path of the GHGs represents or corresponds to an amount of GHG emissions attributable to the one or more entities consuming or utilizing the power or energy.

4. The method of claim 2, wherein the flow of GHGs represents or corresponds to an amount of GHG emissions attributable to the one or more entities based on a financial obligation or responsibility of the one or more entities for the power or energy.

5. The method of claim 3, wherein the amount of GHG emissions attributable to the one or more entities consuming or utilizing the power or energy corresponds to an amount of GHG emissions generated to produce the power or energy consumed or utilized by the one or more entities.

6. The method of claim 3, wherein the amount of GHG emissions attributable to the one or more entities corresponds to an amount of GHG emissions generated to produce power or energy for which the one or more entities have a financial obligation or responsibility.

7. The method of claim 1, wherein in (b), the generation, sale, transmission, or receipt of the power or energy is modeled based at least in part on a physical transmission of power or energy between the one or more sources and the one or more entities.

8. The method of claim 1, wherein in (b), the generation, sale, transmission or receipt of the power or energy is determined based at least in part on the financial ownership of the power or energy or an obligation for the power or energy.

9. The method of claim 1, wherein in (b), the financial responsibility is determined based at least in part on the transmission or distribution of the power or energy.

10. The method of claim 1, wherein the GHG intensity or emission values comprise a localized or individualized GHG intensity or emission value corresponding to an amount of GHGs emitted per unit of electrical energy generated.

11. The method of claim 1, wherein the GHG intensity or emission values are computed based on power or energy data from a plurality of sources comprising the one or more sources.

12. The method of claim 11, wherein the GHG intensity or emission values are computed based on a weighted averaging, transformation, or integration of at least a subset of the power or energy data for the plurality of sources.

13. The method of claim 2, wherein the GHG intensity or emission values are computed based at least in part on the transmission, flux, or flow path of the one or more greenhouse gases.

14. The method of claim 1, wherein the GHG intensity or emission values are computed based on at least one local grid factor.

15. The method of claim 14, wherein the at least one local grid factor comprises a type of electricity generated, transmitted, distributed, or consumed.

16. The method of claim 1, further comprising computing power or energy consumption for (i) the one or more sources, (ii) the one or more entities, (iii) the market or exchange for the power or energy, or (iv) the electrically-defined area or region, based on at least one local grid factor.

17. The method of claim 16, wherein the at least one local grid factor comprises a type of electricity generated, transmitted, distributed, or consumed.

18. The method of claim 16, wherein the GHG intensity or emission values are computed based at least in part on the power or energy consumption.

19. The method of claim 1, wherein the power or energy data is associated with one or more financial instruments.

20. The method of claim 19, wherein the one or more financial instruments comprise a power purchase agreement (PPA), a virtual PPA, a market purchase agreement, a guarantee of origin, a renewable energy credit, or a utility tariff.

21. The method of claim 1, wherein the power or energy data comprises ownership information for the one or more sources.

22. The method of claim 1, wherein the power or energy data comprises operational data for the one or more sources, wherein the operational data comprises power or energy generation rates, a type of fuel or source material processed to generate the power or energy, a total amount of electricity generated per unit time, and/or heat rates for the one or more sources.

23. The method of claim 1, wherein the power or energy data comprises data on electricity transmission or distribution.

24. The method of claim 1, wherein the one or more sources comprise a plant or a facility for generating the power or energy.

25. The method of claim 1, wherein the power or energy is transmitted or distributed over a network, a grid, a macrogrid, or a microgrid.

26. The method of claim 25, wherein the network or grid comprises an electrical grid.

27. The method of claim 10, wherein the localized GHG intensity or emission values are computed periodically at a time interval ranging from 1 second to 1 year.

28. The method of claim 27, wherein the localized GHG intensity or emission values are computed hourly.

29. The method of claim 10, wherein the localized GHG intensity or emission values are computed in real time.

30. The method of claim 1, wherein the electrically-defined area or region comprises a balancing area or a subdivision or a subsection thereof.

31. The method of claim 1, wherein the electrically-defined area or region comprises a portion or a section of a grid system or a grid network for receiving, transmitting, and/or distributing the power or energy.

32. A system, comprising at least one processor, an operating system configured to perform executable instructions, a memory, and instructions executable by the at least one processor to cause the at least one processor to perform operations comprising:
(a) receiving or obtaining power or energy data associated with a generation, a transmission, a distribution, or a consumption of power or energy;
(b) modeling the generation, sale, purchase, transmission, distribution, receipt, consumption, or utilization of the power or energy, based at least in part on:
(1) the power or energy data, and
(2) a financial ownership of the power or energy, a financial obligation or responsibility associated with the generation, sale, transmission, distribution, receipt, or consumption of the power or energy, or financial data associated with the generation, sale, transmission, distribution, receipt, or consumption of the power or energy; and
(c) computing or deriving greenhouse gas (GHG) intensity or emission values for (i) one or more sources that generate the power or energy, (ii) one or more entities that consume or utilize the power or energy, (iii) a market or exchange for the power or energy, or (iv) an electrically-defined area or region, based on the modeling.

33. A non-transitory computer-readable storage media encoded with instructions executable by one or more processors to create an application comprising:
(a) a software module receiving or obtaining power or energy data associated with a generation, a transmission, a distribution, or a consumption of power or energy;
(b) a software module modeling the generation, sale, purchase, transmission, distribution, receipt, consumption, or utilization of the power or energy, based at least in part on:
(1) the power or energy data, and
(2) a financial ownership of the power or energy, a financial obligation or responsibility associated with the generation, sale, transmission, distribution, receipt, or consumption of the power or energy, or financial data associated with the generation, sale, transmission, distribution, receipt, or consumption of the power or energy; and
(c) a software module computing or deriving greenhouse gas (GHG) intensity or emission values for (i) one or more sources that generate the power or energy, (ii) one or more entities that consume or utilize the power or energy, (iii) a market or exchange for the power or energy, or (iv) an electrically-defined area or region, based on the modeling.
